(19) United States
(12) Patent Application Publication
(10) Pub. No.: US 2024/0331266 A1
(43) Pub. Date: Oct. 3, 2024

(54) SPHERE-BASED RAY-CAPSULE INTERSECTOR FOR CURVE RENDERING

(71) Applicant: Advanced Micro Devices, Inc., Santa Clara, CA (US)

(72) Inventor: Trevor James Hedstrom, Escondido, CA (US)

(73) Assignee: Advanced Micro Devices, Inc., Santa Clara, CA (US)

(21) Appl. No.: 18/191,800

(22) Filed: Mar. 28, 2023

(51) Int. Cl. G06T 15/06

(52) U.S. Cl. CPC G06T 15/06

(57) ABSTRACT

Devices and methods for rendering curves using ray tracing are provided which include tessellating a curve, representing at least a portion of an object in a scene, into a chain of capsules each comprising two spheres and a connecting cone, generating an acceleration structure comprising the chain of capsules, casting a ray in a space comprising the curve, and performing, for a capsule of the chain of capsules, a closed-form intersection test to render the curve. In a first example, the closed-form intersection test is performed using a single quadratic equation quadratic based on coefficients from input values of the two spheres. In a second example, the closed-form intersection test is performed based on an intersection between the ray and a blended sphere generated from a smallest distance between the ray and a centerline of the capsule and an offset.

### BACKGROUND

Ray tracing is a type of graphics rendering technique in which simulated rays of light are cast to test for object intersection and pixels are illuminated and colored based on the result of the ray cast. Ray tracing is computationally more expensive than rasterization-based techniques, but produces more physically accurate results. Improvements in ray tracing operations are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more features of the disclosure can be implemented;

FIG. 2 is a block diagram of the device, illustrating additional details related to execution of processing tasks on the accelerated processing device of FIG. 1, according to an example;

FIG. 3 illustrates a ray tracing pipeline for rendering graphics using a ray tracing technique, according to an example;

FIG. 4 is an illustration of a bounding volume hierarchy, according to an example;

FIG. 5 is a flow diagram illustrating an example method of rendering curves using ray tracing according to features of the present disclosure;

FIG. 6A is an example of primitives of a scene in which one or more features of the disclosure can be implemented;

FIG. 6B is an illustration of a bounding volume hierarchy, according to an example;

FIG. 7. is a flow diagram illustrating a method of performing a ray-capsule intersection test according to a first example;

FIG. 8. is a diagram illustrating an example capsule and different rays used to perform ray-capsule intersection tests according to one or more features of the disclosure;

FIG. 9. is a flow diagram illustrating a method of performing a ray-capsule intersection test according to a second example;

FIG. 10 is diagram of a portion of a capsule used to illustrate a method of determining a location of a blended sphere along a centerline of the capsule according to an example;

FIG. 11A is a diagram illustrating an example of the blended sphere shown in FIG. 10 at a first location along the centerline of the capsule;

FIG. 11B is a diagram illustrating an example of the blended sphere shown in FIG. 10 at a second location along the centerline of the capsule shown in FIG. 11A;

FIG. 11C is a diagram illustrating an example of the blended sphere shown in FIG. 10 at a third location along the centerline of the capsule shown in FIG. 11A; and

FIG. 12 is a flow diagram illustrating an example method of rendering curves using ray tracing according to features of the present disclosure.

### DETAILED DESCRIPTION

As described above, each ray intersection test is expensive in terms of processing resource. Triangles are used in ray tracing because they are linear and, therefore, the equations used to represent the ray-triangle intersections are first-degree polynomials. However, intersection of a ray with a complex primitive other than a triangle is performed with complex math, such as by determining roots of polynomials, resulting in even more expensive ray intersection tests.

More specifically, scenes typically include a variety of different objects, or portions of objects, which are rendered using curves (in contrast to triangles). For example, curves are used to render hair, fur, grass, clothing (e.g., thread, yarn, fibers) as well as a variety of other curved objects or curved portions of objects in a scene. In addition, some curved objects (e.g., hair) are thicker at one end and gradually taper off and become thinner at the other end. Similar to other types of primitives (e.g., triangles) in a scene, the curves (e.g., curved objects or curved portions of objects) are rendered by testing whether the ray intersects the curves. However, these curves cannot be efficiently and accurately rendered using linear primitives (e.g., triangles).

Accordingly, some conventional ray-curve intersection techniques include determining roots of complicated polynomials, such as computing the intersection of a ray and a quadratic Bezier curve which involves solving a cubic polynomial. However, these conventional ray-curve intersection techniques are inefficient because the intersections of rays with higher-order curves are not solvable in closed-form (i.e., they require iteratively refining the solution to approximate the intersections of rays with the curves). Other conventional techniques include tessellating curves into ray-facing billboards and intersecting the billboards, which produce visually noticeable artifacts.

It is possible to use capsule-based intersection tests to render curves in a scene. The capsules represent the union of two spheres and a tangent cone connecting the spheres. Multiple capsules are chained together to represent a curve (e.g., curved object) in a scene. However, some capsule-based techniques are inefficient because they include naive sphere and cone intersectors which do not account for precision issues (e.g., false intersections or misses) and require intersecting both the spheres and the body of the cylinder or cone (i.e., require 3 intersectors).

Features of the present disclosure provide efficient ray-capsule intersector testing techniques for rendering curves in a scene. Ray-capsule intersection tests are implemented as closed-form solutions (i.e., solving quadratic equations without multiple iterations to refine the solution). Features of the present disclosure more efficiently render curves in a scene, including some curved objects by tessellating the curves into multiple spheres of progressively smaller radii.

In a first example of a ray-capsule intersection test, in response to a determination that a ray intersects a cone of the capsule, the ray-capsule intersection is determined by solving a single quadratic equation (using the coefficients for the ray-cone intersection) when the ray intersects the cone in a first region between the two spheres of the capsule. When the ray intersects the cone in a region outside the first region, a closest shape (e.g., closest of the two spheres and cone to a ray origin) to the ray origin is determined and the ray-capsule intersection is determined by solving a single quadratic equation (using the coefficients for the ray-sphere intersection). That is, in contrast to performing three intersection tests (which includes solving three separate quadratic equations for each test that is expensive to implement in hardware) for the two spheres and the cone (making up the capsule) and then using the ray-capsule intersection having the smallest distance to the ray origin (i.e., the intersection having minimum valid intersection distance from the ray origin) as the final point of intersection, the ray-capsule intersection test implemented according to the first example uses a single ray-capsule intersection and, therefore, solves a single quadratic equation (i.e., the quadratic equation resulting in the smallest t-value) to perform the ray-capsule intersection test.

The computationally expensive transcendental (i.e., non-algebraic) operations used to solve the single quadratic equation are performed at the end of the ray tracing pipeline, which improves hardware throughput. Additionally, if the ray is determined to not intersect the capsule, the computationally expensive transcendental (i.e., non-algebraic) operations are avoided because no quadratic equation is solved. Accordingly, the ray-capsule intersection test implemented according to the first example is performed more efficiently (e.g., in less time and less power consumption) than conventional ray-capsule intersection techniques.

In a second example, the ray-capsule intersection test is performed by calculating a closest distance (e.g., closest approach) between a ray and a capsule centerline (i.e., a center line connecting the two spheres of the capsule). An offset is calculated (by solving a first quadratic equation) relative to the centerline to generate a blended sphere (e.g., sphere interpolated from the two end spheres of the capsule) at a location along the centerline intersected by the ray to determine the ray-sphere intersection. The ray-capsule intersection is then determined by solving a second quadratic equation using quadratic coefficients for the ray-sphere intersection.

While the ray-capsule intersection implemented according to the first example is more efficient than conventional ray-capsule intersection techniques (as described above), when the distance between the ray origin and the capsule (relative to the radii of the spheres) is large, the precision can be negatively affected (e.g., floating point error due to an insufficient number of decimal places which increases the probability of false intersections or misses occurring).

The ray-capsule intersection implemented according to the second example is also more efficient than conventional ray-capsule intersection techniques because it includes solving two quadratic equations (which is still more efficient than solving three quadratic equations performed by conventional ray-capsule intersection techniques). While the ray-capsule intersection test implemented according to the second example may be performed less efficiently (in terms of time and power because of solving two quadratic equations instead of a single quadratic equation) than the ray-capsule intersection tests according to first example, the ray-capsule intersection implemented according to the second example is more precise for cases when the ray origin is far from the capsule.

A method of rendering curves using ray tracing is provided which comprises tessellating a curve, representing at least a portion of an object in a scene, into a chain of capsules each comprising a first sphere, a second sphere and a cone connecting the first sphere and the second sphere, generating an acceleration structure comprising the chain of capsules, casting a ray in a space comprising the curve, performing, for a capsule of the chain of capsules, a closed-form intersection test between the ray and the capsule using a single quadratic equation, and rendering the curve based on the closed-form intersection test

A processing device for rendering curves using ray tracing is provided which comprises memory and a processor. The processor is configured to tessellate a curve, representing at least a portion of an object in a scene, into a chain of capsules each comprising a first sphere, a second sphere and a cone connecting the first sphere and the second sphere, generate an acceleration structure comprising the chain of capsules, cast a ray in a space comprising the curve, perform, for a capsule of the chain of capsules, a closed-form intersection test between the ray and the capsule using a single quadratic equation, and render the curve based on the closed-form intersection test.

A method of rendering curves using ray tracing is provided which comprises tessellating a curve, representing at least a portion of an object in a scene, into a chain of capsules each comprising a first sphere, a second sphere and a cone connecting the first sphere and the second sphere, generating an acceleration structure comprising the chain of capsules, casting a ray in a space comprising the curve, for a capsule of the chain of capsules: determining a smallest distance between the ray and a centerline of the capsule; calculating an offset along the centerline of the capsule; and performing a ray-capsule intersection test based on an intersection between the ray and a blended sphere generated from the offset, and rendering the curve based on the ray-capsule intersection test.

A processing device for rendering curves using ray tracing is provided which comprises memory and a processor. The processor is configured to tessellate a curve, representing at least a portion of an object in a scene, into a chain of capsules each comprising a first sphere, a second sphere and a cone connecting the first sphere and the second sphere, generate an acceleration structure comprising the chain of capsules, cast a ray in a space comprising the curve, for a capsule of the chain of capsules: determine a smallest distance between the ray and a centerline of the capsule; calculate an offset along the centerline of the capsule; and perform a ray-capsule intersection test based on an intersection between the ray and a blended sphere generated from the offset, and render the curve based on the ray-capsule intersection test.

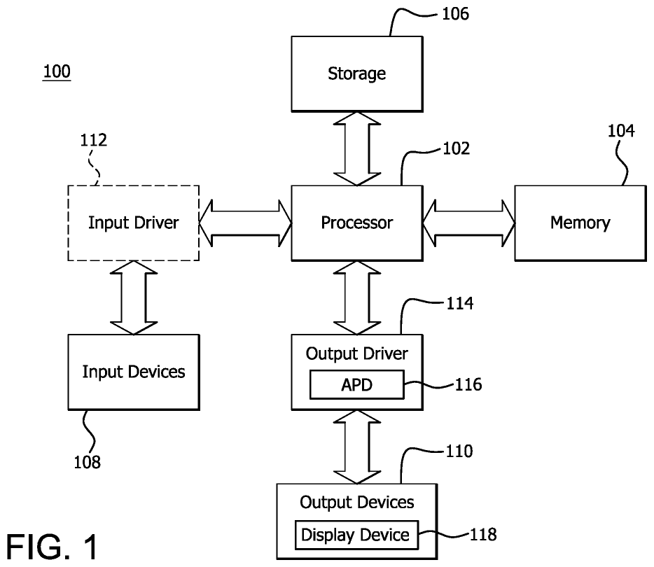

FIG. 1 is a block diagram of an example device 100 in which one or more features of the disclosure can be implemented. The device 100 includes, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 also optionally includes an input driver 112 and an output driver 114. It is understood that the device 100 includes additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or DisplayPort compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD 116 is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide (graphical) output to a display device 118. For example, it is contemplated that any processing system that performs processing tasks in accordance with a SIMD paradigm can be configured to perform the functionality described herein. Alternatively, it is contemplated that computing systems that do not perform processing tasks in accordance with a SIMD paradigm performs the functionality described herein.

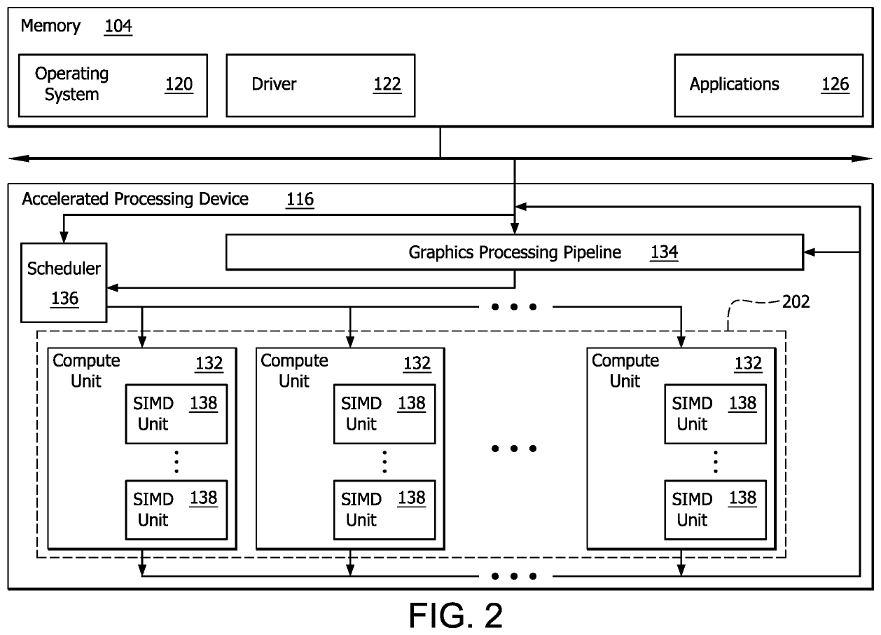

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some implementations, the driver 122 includes a just-in-time compiler that compiles programs for execution by processing components (such as the SIMD units 138 discussed in further detail below) of the APD 116. In other implementations, no just-in-time compiler is used to compile the programs, and a normal application compiler compiles shader programs for execution on the APD 116.

The APD 116 executes commands and programs for selected functions, such as graphics operations and non-graphics operations that are suited for parallel processing and/or non-ordered processing. The APD 116 is used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 (collectively “compute units 202”) that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but executes that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. In an implementation, each of the compute units 132 can have a local L1 cache. In an implementation, multiple compute units 132 share a L2 cache.

The basic unit of execution in compute units 132 is a work-item. Each work-item represents a single instantiation of a program that is to be executed in parallel in a particular lane. Work-items can be executed simultaneously as a “wavefront” (also “waves”) on a single SIMD processing unit 138. One or more wavefronts are included in a “work group,” which includes a collection of work-items designated to execute the same program. A work group is executed by executing each of the wavefronts that make up the work group. In alternatives, the wavefronts are executed sequentially on a single SIMD unit 138 or partially or fully in parallel on different SIMD units 138. A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

The compute units 132 implement ray tracing, which is a technique that renders a 3D scene by testing for intersection between simulated light rays and objects in a scene. Much of the work involved in ray tracing is performed by programmable shader programs, executed on the SIMD units 138 in the compute units 132, as described in additional detail below.

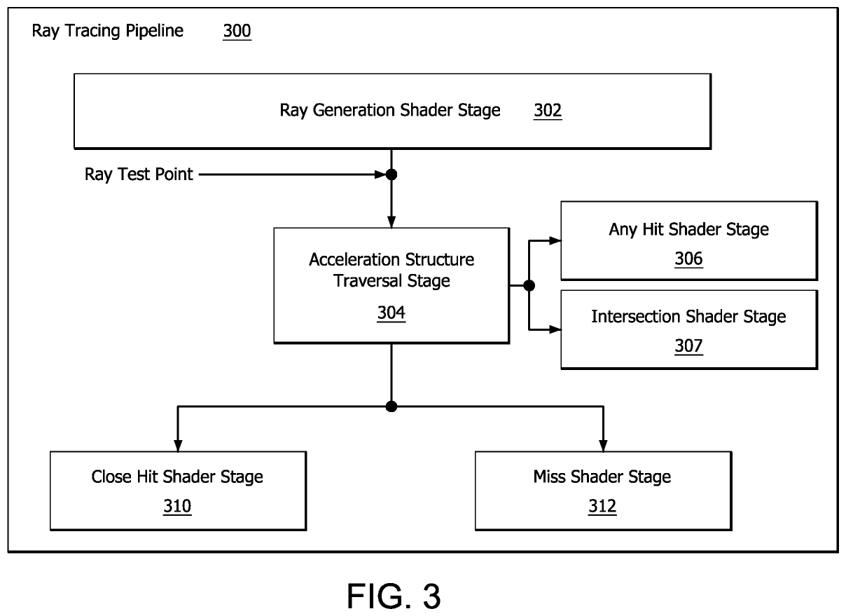

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, intersection shader 307, closest hit shader 310, and miss shader 312 are shader-implemented stages that represent ray tracing pipeline stages whose functionality is performed by shader programs executing on the SIMD unit 138. Any of the specific shader programs at each particular shader-implemented stage are defined by application-provided code (i.e., by code provided by an application developer that may pre-compiled by an application compiler and/or compiled by the driver 122). It should be noted that in variations, these stages can be implemented using specialized, fixed function or programmable circuitry. The acceleration structure traversal stage 304 performs the ray intersection test to determine whether a ray hits a triangle. The other programmable shader stages (ray generation shader 302, any hit shader 306, closest hit shader 310, miss shader 312) are implemented as shader programs that execute on the SIMD units 138. The acceleration structure traversal stage may be implemented in software (e.g., as a shader program executing on the SIMD units 138), in hardware, or as a combination of hardware and software. The ray tracing pipeline 300 may be orchestrated partially or fully in software or partially or fully in hardware, and may be orchestrated by the processor 102, the scheduler 136, by a combination thereof, or partially or fully by any other hardware and/or software unit. In examples, traversal through the ray tracing pipeline 300 is performed partially or fully by the scheduler 136, either autonomously or under control of the processor 102, or partially or fully by a shader program (such as a BVH traversal shader program) executing on one or more of the SIMD units 138. In some examples, testing a ray against boxes and triangles (inside the acceleration structure traversal stage 304) is hardware accelerated (meaning that a fixed function hardware unit performs the steps for those tests). In other examples, such testing is performed by software such as a shader program executing on one or more SIMD units 138. Herein, where the phrase “the ray tracing pipeline does [a task]” is used, this means that the hardware and/or software that implements the ray tracing pipeline 300 does that task.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects within the scene, and tests the ray against triangles in the scene. During this traversal, for triangles that are intersected by the ray, the ray tracing pipeline 300 triggers execution of an any hit shader 306 and/or an intersection shader 307 if those shaders are specified by the material of the intersected triangle. Note that multiple triangles can be intersected by a single ray. It is not guaranteed that the acceleration structure traversal stage will traverse the acceleration structure in the order from closest-to-ray-origin to farthest-from-ray-origin. The acceleration structure traversal stage 304 triggers execution of a closest hit shader 310 for the triangle closest to the origin of the ray that the ray hits, or, if no triangles were hit, triggers a miss shader.

Note, it is possible for the any hit shader 306 or intersection shader 307 to “reject” an intersection from the acceleration structure traversal stage 304, and thus the acceleration structure traversal stage 304 triggers execution of the miss shader 312 if no intersections are found to occur with the ray or if one or more intersections are found but are all rejected by the any hit shader 306 and/or intersection shader 307. An example circumstance in which an any hit shader 306 may “reject” a hit is when at least a portion of a triangle that the acceleration structure traversal stage 304 reports as being hit is fully transparent. Because the acceleration structure traversal stage 304 only tests geometry, and not transparency, the any hit shader 306 that is invoked due to an intersection with a triangle having at least some transparency may determine that the reported intersection should not count as a hit due to “intersecting” a transparent portion of the triangle. A typical use for the closest hit shader 310 is to color a ray based on a texture for the material. A typical use for the miss shader 312 is to color a ray with a color set by a skybox. It should be understood that the shader programs defined for the closest hit shader 310 and miss shader 312 may implement a wide variety of techniques for coloring ray and/or performing other operations.

A typical way in which ray generation shaders 302 generate rays is with a technique referred to as backwards ray tracing. In backwards ray tracing, the ray generation shader 302 generates a ray having an origin at the point of the camera (i.e., the eye of the viewer). The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel.

It is possible for any of the any hit shader 306, intersection shader 307, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray intersects an object is referred to herein as a “ray intersection test.” The ray intersection test involves shooting a ray from an origin and determining whether the ray intersects a triangle and, if so, what distance from the origin the triangle intersection is at. For efficiency, the ray tracing test uses a representation of space referred to as a bounding volume hierarchy. This BVH is the “acceleration structure” referred to elsewhere herein. In a BVH, each non-leaf node represents an AABB that bounds the geometry of all children of that node. In an example, the base node represents the maximal extents of an entire region for which the ray intersection test is being performed. In this example, the base node has two children that each represent mutually exclusive AABBs that subdivide the entire region. Each of those two children has two child nodes that represent AABBs that subdivide the space of their parents, and so on. Leaf nodes represent a triangle or other geometry against which a ray intersection test can be performed.

The BVH data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against AABBs, followed by tests against triangles.

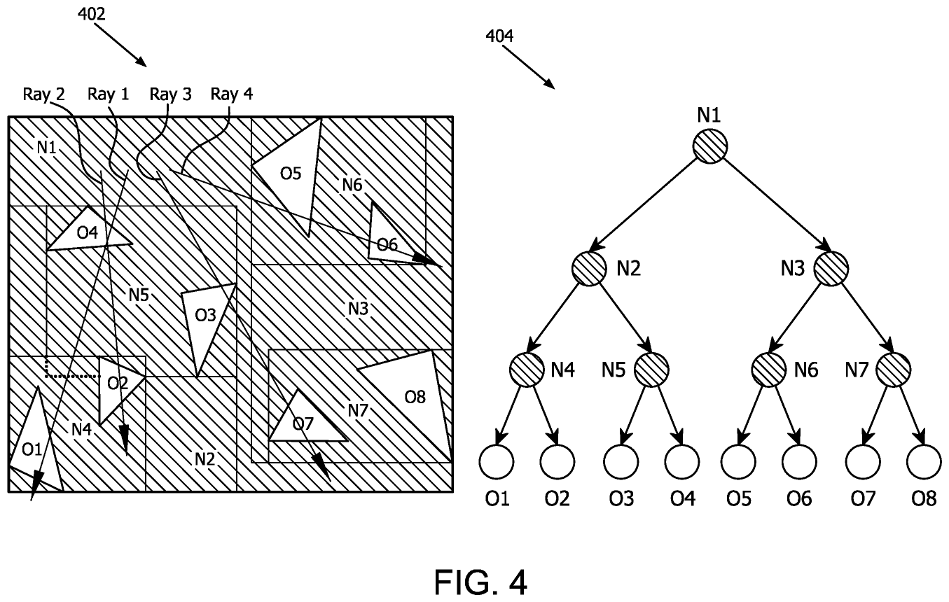

FIG. 4 is an illustration of a BVH, according to an example. For simplicity, the hierarchy is shown in 2 dimensions. However, extension to 3 dimensions is simple, and it should be understood that the tests described herein would generally be performed in three dimensions.

The spatial representation 402 of the BVH is illustrated in the left side of FIG. 4 and the tree representation 404 of the BVH is illustrated in the right side of FIG. 4. The non-leaf nodes are represented with the letter “N” and the leaf nodes are represented with the letter “O” in both the spatial representation 402 and the tree representation 404.

For simplified explanation purposes, triangles are shown as the primitives in the example shown in FIG. 4. As described in more detail below, however, primitives can include capsules and capsule chains for rendering curves in a scene and nodes of a BVH tree can include the capsules.

A conventional ray intersection test for tree representation 404 would be performed by traversing through the tree 404, and, for each non-leaf node tested, eliminating branches below that node if the test for that non-leaf node fails. However, when a ray intersects an AABB (i.e., if the test for a non-leaf node succeeds), conventional ray traversal algorithms will continue traversal within the AABB until the test reaches a leaf node. For example, if the ray intersects O₅ but no other triangle, the conventional ray intersection test would test against N₁, determining that a ray intersects an AABB (i.e., the test succeeds for N₁). The test would test against N₂, determining that the test fails (since O₅ is not within N₂) and the test would eliminate all sub-nodes of N₂. Because the test against N₁ resulted in a determination that the ray intersected an AABB, traversal would continue to the child nodes of N₁, and would test against N₃, determining that a ray intersects an AABB (i.e., the test succeeds). Because the test against N₃ resulted in a determination that the ray intersected an AABB, traversal would again continue to the child nodes of N₃, and would test N₆ and N₇, determining that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

The ray tracing pipeline 300 casts rays to detect whether the rays hit triangles and how such hits should be shaded (e.g., how to calculate levels of brightness and color of pixels representing objects) during the rendering of a 3D scene. Each triangle is assigned a material, which specifies which closest hit shader should be executed for that triangle at the closest hit shader stage 310, as well as whether an any hit shader should be executed at the any hit shader stage 306, whether an intersection shader should be executed at the intersection shader stage 307, and the specific any hit shader and intersection shader to execute at those stages if those shaders are to be executed.

Thus, in shooting a ray, the ray tracing pipeline 300 evaluates intersections detected at the acceleration structure traversal stage 304 as follows. If a ray is determined to intersect a triangle, then if the material for that triangle has at least an any hit shader or an intersection shader, the ray tracing pipeline 300 runs the intersection shader and/or any hit shader to determine whether the intersection should be deemed a hit or a miss. If neither an any hit shader or an intersection shader is specified for a particular material, then an intersection reported by the acceleration structure traversal 304 with a triangle having that material is deemed to be a hit.

Some examples of situations where an any hit shader or intersection shader do not count intersections as hits are now provided. In one example, if alpha is 0, meaning fully transparent, at the point that the ray intersects the triangle, then the any hit shader deems such an intersection to not be a hit. In another example, an any hit shader determines that the point that the ray intersects the triangle is deemed to be at a “cutout” portion of the triangle (where a cutout “cuts out” portions of a triangle by designating those portions as portions that a ray cannot hit), and therefore deems that intersection to not be a hit.

Once the acceleration structure has been fully traversed, the ray tracing pipeline 300 runs the closest hit shader 310 on the closest triangle determined to hit the ray. As with the any hit shader 306 and the intersection shader 307, the closest hit shader 310 to be run for a particular triangle is dependent on the material assigned to that triangle.

In sum, a ray tracing pipeline 300 typically traverses the acceleration structure 304, determining which triangle is the closest hit for a given ray. The any hit shaders and intersection shaders evaluate intersections—potential hits—to determine if those intersections should be counted as actual hits. Then, for the closest triangle whose intersection is counted as an actual hit, the ray tracing pipeline 300 executes the closest hit shader for that triangle. If no triangles count as a hit, then the ray tracing pipeline 300 executes the miss shader for the ray.

Operation of typical ray tracing pipeline 300 is now discussed with respect to the example rays 1-4 illustrated in FIG. 4. For each of the example rays 1-4, the ray tracing pipeline 300 determines which triangles (or other primitives, such as capsules as described in more detail below) those rays intersect. The ray tracing pipeline 300 executes appropriate any hit shaders 306 and/or intersection shaders 307, as specified by the materials of the intersected triangles, in order to determine the closest hit that does not miss (and thus the closest-hit triangle). The ray tracing pipeline 300 runs the closest hit shader for that closest-hit triangle.

In an example, for ray 1, the ray racing pipeline 300 runs the closest hit shader for 04 unless that triangle had an any hit shader or intersection shader that, when executed, indicated that ray 1 did not hit that triangle. In that situation, the ray tracing pipeline 300 would run the closest hit shader for O₁ unless that triangle had an any hit shader or intersection shader indicating that triangle was not hit by ray 1, and in that situation, the ray tracing pipeline 300 would execute a miss shader 312 for ray 1. Similar operations would occur for rays 2, 3, and 4. For ray 2, the ray tracing pipeline 300 determines that intersections occur with O2 and O4, executes an any hit and/or an intersection shader for those triangles if specified by the material, and runs the appropriate closest hit or miss shader. For rays 3 and 4, the ray tracing pipeline 300 determines intersections as shown (ray 3 intersects O3 and O7 and ray 4 intersects O5 and O6), executes appropriate any hit and an/or intersection shaders, and executes appropriate closest hit or miss shaders based on the results of the any hit and/or intersection shaders.

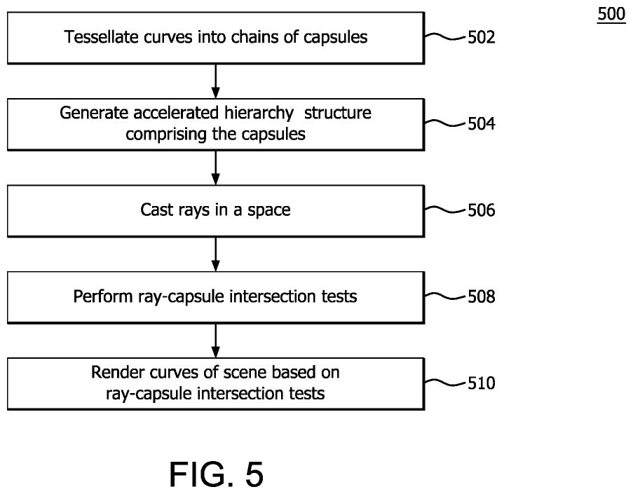

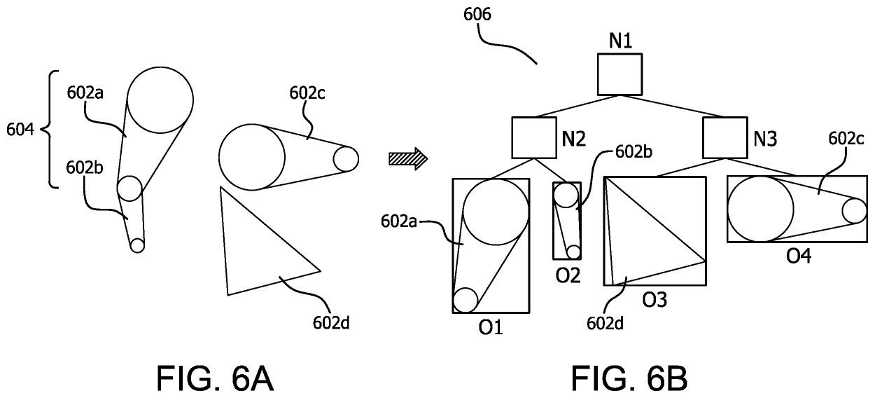

FIG. 5 is a flow diagram illustrating an example method 500 of rendering curves using ray tracing according to features of the present disclosure. The method 500 is described using the example primitives 602a to 602d shown in FIG. 6A and the example BVH tree representation 604 shown in FIG. 6B.

As shown at block 502, the method 500 includes tessellating curves into a chain of capsules. Specifically, a chain of capsules is generated where the outline of the chain roughly follows the curve. The objects in a scene are tessellated into primitives (e.g., capsules, triangles, or other primitives), which includes tessellating each curve of the objects into a chain of capsules (i.e., dividing the data representing each curve into a chain of capsules for rendering). In other words, from objects in a scene that include curves, multiple capsules are generated, where the capsules form chains, which represent the curves of the objects. For example, as shown in FIG. 6A, the primitives include a capsule chain 604 comprising capsule 602a and 602b, capsule 602c and triangle 602d. The capsule chain 604 is used to represent a curve of a portion of an object in the scene. The portion of an object can be a part of the object or the whole object. Each capsule is the convex hull of two spheres and neighboring capsules on a chain share endpoints. For example, as shown in FIG. 6A, capsules 602a and 602b of capsule chain 604 share endpoints (e.g., points on the middle sphere of the capsule chain 604).

Data for the two spheres of a capsule, including data representing the location and radii of the spheres, is stored for example using 32-bit floating point values (e.g., two float4 values). An inverse-length term can also be included to avoid a division (i.e., avoiding the division of data for both spheres) in the ray tracing pipeline. An amount of memory (e.g., 32 bytes or more) is allocated for data representing each capsule to facilitate an efficient ray tracing pipeline. For example, the reciprocal of the length of the capsule is precomputed in software and used throughout the ray tracing pipeline to avoid expensive computation using hardware. Additional bytes (e.g., 64 bytes or more) of data can be precomputed, leading to a small tradeoff between an amount of storage used for precomputation and pipeline depth.

The number and type of primitives shown in FIG. 6A are merely an example. Features of the present disclosure can be implemented to render curves in scenes having any number of primitives as well as types of primitives different than those show in FIG. 6A.

As shown at block 504, the method 500 includes generating an acceleration structure comprising the capsules. That is, an acceleration structure (e.g., BVH structure) is generated which includes the capsules and other primitives of the scene. For example, the accelerated BVH structure (i.e., the BVH tree representation 606) in FIG. 6B is generated which includes the capsules 602a, 602b and 602c and triangle 602d. As described above with regard to the BVH tree representation 404 in FIG. 4, the hierarchy in FIG. 6B is shown in 2 dimensions for simplicity. However, extension to 3 dimensions is simple, and it should be understood that the tests described herein would generally be performed in three dimensions. In addition, the non-leaf nodes of the BVH tree representation 604 are represented with the letter “N” and the leaf nodes are represented with the letter “O.”

As shown in the BVH tree representation 606 at FIG. 6B, capsule 602a is represented by leaf node O₁, capsule 602b is represented by leaf node O2, capsule 602c is represented by leaf node O3, and triangle 602d is represented by leaf node O4. A ray tracing pipeline operates similarly to the operation discussed above with regard to FIG. 4. For example, the BVH tree 606 is traversed similar to the traversal of the BVH tree 404.

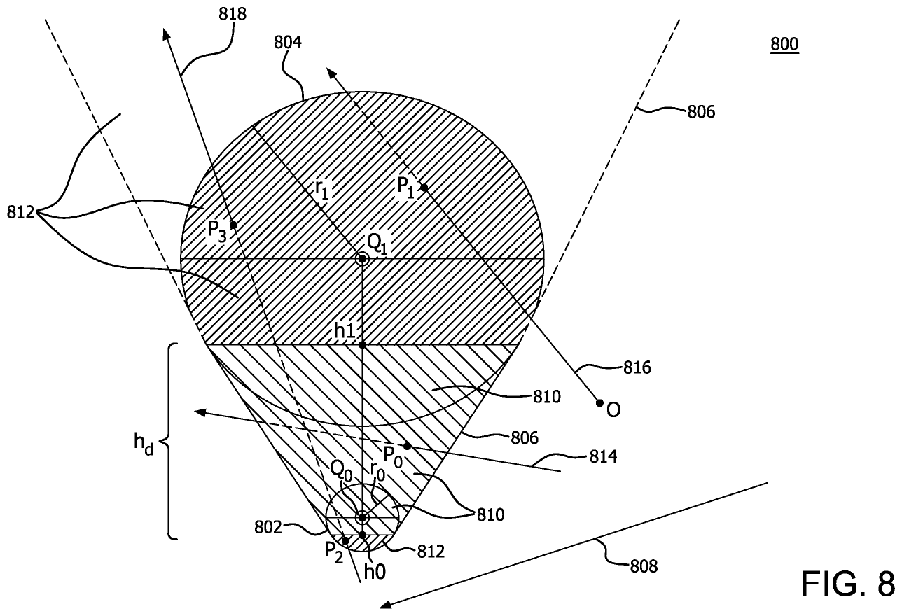

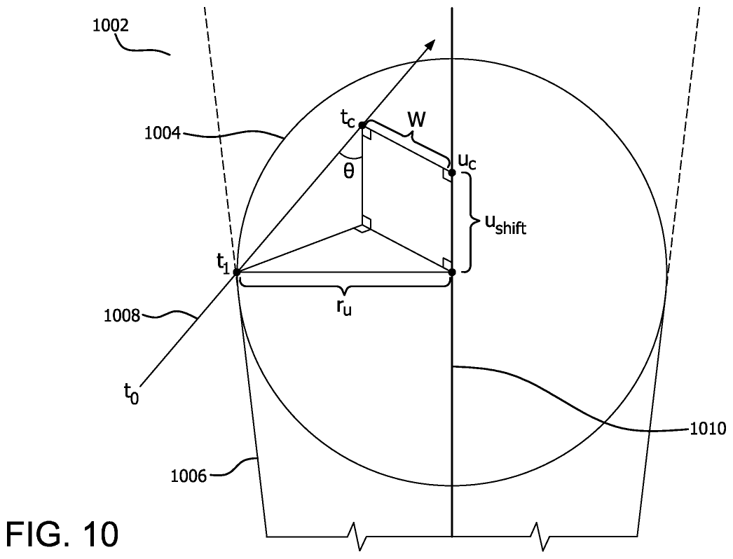

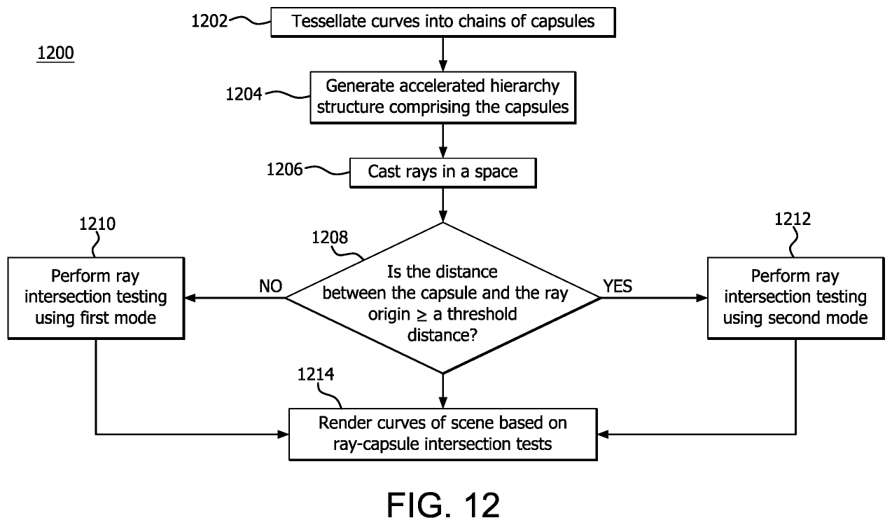

As shown at block 506, the method 500 includes casting rays in a space (e.g., 3D space). For example, a ray is cast in a space which includes the example primitives 602a to 602d shown in FIG. 6A. Examples of cast rays are shown in FIG. 8, FIG. 10 and FIG. 12 and are described in more detail below.

As shown at block 508, the method 500 includes performing intersection tests between the rays and capsules (i.e., ray-capsule intersection tests) in a scene. That is, as described above, ray tracing renders a 3D scene by testing whether a cast ray intersects an object in a scene to determine the presence of objects and a variety of characteristics of objects in a scene.

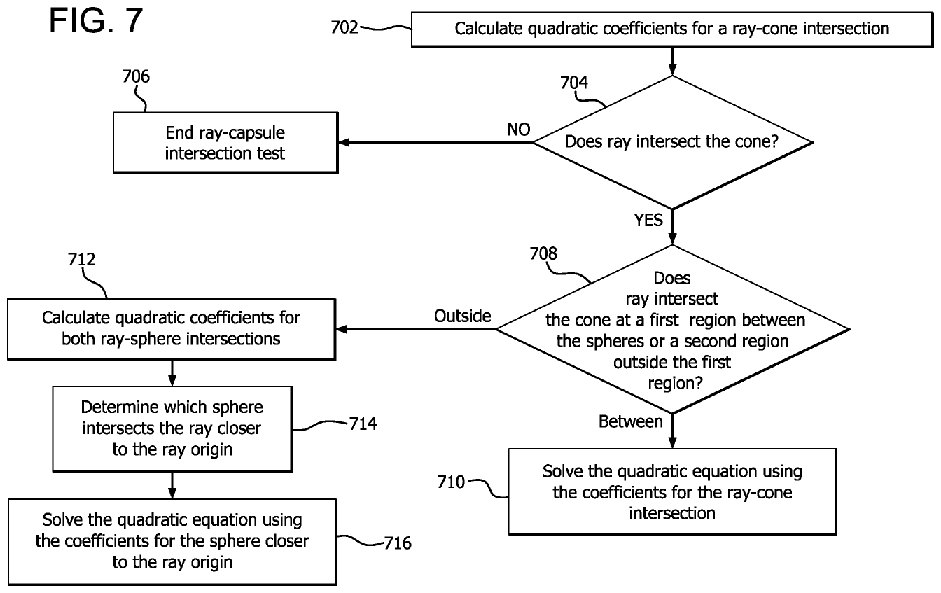

FIG. 7. is a flow diagram illustrating a method 700 of performing a ray-capsule intersection test (shown at block 508 of FIG. 5) according to a first example. The method 700 is described using the example ray-capsule 800 shown in FIG. 8. The diagram shown in FIG. 8 is illustrated as a two dimensional (2D) representation of a 3D space. As shown, ray-capsule 800 includes a first sphere 802, a second sphere 803 and cone 806. That is, ray-capsule 800 is the union of spheres 802 and 804 and a region of the cone 806 between spheres 802 and 804.

For example, with reference to FIG. 8, points (p) on the spheres 802 and 804 (e.g., P₁ on sphere 804 in FIG. 8) are described by Equation 1 and Equation 2 below:

$${‖ p - {Q}_{0} ‖}^{2} = {{r}_{0}}^{2} \qquad Equation 1$$

$${‖ p - {Q}_{1} ‖}^{2} = {{r}_{1}}^{2} , \qquad Equation 2$$

where Q₀ is the center of the sphere 802, Q₁ is the center of the sphere 804, r₀ is the radii of the sphere 802, and r₁ is the radii of the sphere 804.

Points (p) on the cone 806 (e.g., point P₀ in FIG. 8) are defined below by Equation 3:

$${‖ p - ( {h}_{0} + {h}_{1} \cdot {u}_{h} ( p ) ) ‖}^{2} = s \cdot {( {r}_{0} + ( {r}_{1} - {r}_{0} ) \cdot {u}_{h} ( p ) )}^{2} , \qquad Equation 3$$

where uₕ is a scalar representing a distance from the origin of the ray to a point p along the axis of the capsule 800, as defined below by Equation 4:

$${u}_{h} ( p ) = \frac{( p - {h}_{0} ) \cdot {h}_{1}}{{‖ {h}_{1} ‖}^{2}} , \qquad Equation 4$$

where h₀ is the point along the capsule axis (e.g., horizontal axis intersecting point h₀ in FIG. 8) where the cone meets the sphere Q₀, as defined below by Equation 5:

$${h}_{0} = \frac{( p - {h}_{0} ) \cdot {h}_{d}}{{‖ {h}_{1} ‖}^{2}} , \qquad Equation 5$$

where h_{d} is the vector along the capsule's axis, such that h₀+h_{d} is the point h₁ along the capsule axis (e.g., horizontal axis intersecting point h₁ in FIG. 8) where the cone meets the sphere Q₁, as defined below by Equation 6:

$${h}_{1} = s \cdot ( {Q}_{1} - {Q}_{0} ) , \qquad Equation 6$$

A scale factor s for the tangent cone 806 is defined below by Equation 7.

$$s = \frac{{( {r}_{1} - {r}_{0} )}^{2}}{{‖ {Q}_{1} - {Q}_{0} ‖}^{2}} , \qquad Equation 7$$

As shown at block 702 in FIG. 7, the method 700 of performing a ray-capsule intersection test includes calculating quadratic coefficients for a ray-cone intersection (i.e., quadratic coefficients for an intersection of the ray and the cone of a capsule). The quadratic coefficients (e.g., a, b and c coefficients of the quadratic equation ax²+bx+c) are calculated from the input values of the centers of the two spheres, the radii of the two spheres, the ray origin and the ray direction. For example, for the capsule 800 shown in FIG. 8, the quadratic coefficients for a ray-cone intersection (i.e., intersection between one of the rays 808, 814, 816 or 818 and the cone 806 shown in FIG. 8) are calculated from the input values corresponding to the center (Q₀) of sphere 802, the center (Q₁) of sphere 804, the radius (r₀) of sphere 802, the radius (r₁) of sphere 804, and the origin and direction of the corresponding ray.

As shown at decision block 704, the method 700 includes determining whether the ray intersects the cone 806 based on the quadratic coefficients for an intersection of the ray and the cone 806, determined at block 702.

In response to the determination that the ray does not intersect the cone (NO decision), the ray-capsule intersection test ends at block 706. For example, if ray 808 is cast, in response to a determination that the ray 808 (shown in FIG. 8) does not intersect the cone 806 of ray-capsule 800, the ray-capsule intersection test ends. Traversal of the BVH tree then continues to another node as described above.

In response to the determination that the ray does intersect the cone 806 (YES decision), the method 700 proceeds to decision block 708 to determine whether the ray intersects the cone at a first region between the two spheres of the capsule (e.g., region between the horizontal axis intersecting point h₀ and the horizontal axis intersecting point h₁ in FIG. 8) or whether the ray intersects the cone at a second region outside the first region (i.e., a second region not between the two spheres). For example, a determination is made as to whether or not the ray (e.g., one of the rays 810, 814 and 816) intersects the cone 806 in the first region 810 between the two spheres 802 and 804 or in the second region 812 outside (e.g., above as shown in FIG. 8) the region 810.

Although the example method 700 described above includes first determining, at decision block 704, whether the ray (e.g., ray 808, ray 814, ray 816, or ray 814) intersects the cone (e.g., cone 806) between the two spheres (e.g., spheres 802 and 804) and then determining, at decision block 708, whether the ray intersects the cone (e.g., cone 806) at the first region (e.g., region 810) between the two spheres or at the second region (e.g., region 812) outside the first region, the determinations made at decision blocks 704 and 708 can also be performed in reverse order or can be performed in parallel.

In response to the determination that the ray intersects the cone between the two spheres, the quadratic equation is solved at block 710 using the coefficients for the ray-cone intersection calculated at block 702. For example, in response to the determination that ray 814 (shown in FIG. 8) intersects the cone 806 between the two spheres 802 and 804 at point P₀ in region 810, the quadratic equation is solved using the coefficients for the ray-cone intersection to determine the final point of intersection.

In response to the determination that the ray intersects the cone outside of the region between the two spheres (e.g., the ray intersects one of the spheres or both of the spheres), quadratic coefficients are calculated at block 712 for the ray-sphere intersection of both spheres. For example, in response to the determination that ray 816 intersects the cone 806 at point P₁ in region 812 outside the region 810 between the two spheres 802 and 804 (or alternatively in response to ray 818 intersecting the cone 806 at point P₂ in region 812), quadratic coefficients are calculated, at block 712, for both the ray-sphere intersection of sphere 802 and the ray-sphere intersection of sphere 804. That is, quadratic coefficients (e.g., a, b and c coefficients of the quadratic equation ax²+bx+c) are calculated for the ray-sphere intersection of sphere 802 from the input values corresponding to the center (Q₀) of sphere 802, the radius (r₁) of sphere 804, and the origin and direction of ray 816 and quadratic coefficients are calculated for the ray-sphere intersection of sphere 804 from the input values corresponding to the center (Q₁) of sphere 804, the radius (r₁) of sphere 804, and the origin and direction of ray 816.

As shown at decision block 714, the method 700 includes determining which of the two spheres intersects the ray closer to the ray origin using the quadratic coefficients calculated, at block 712, for both spheres. For example, for the ray-capsule intersection test of ray 816, the calculated quadratic coefficients are used to determine whether sphere 802 or sphere 804 intersects the ray 816 closer to the origin (point O) of ray 816.

The quadratic equation is then solved, at block 716, using the quadratic coefficients (e.g., a, b and c coefficients of the quadratic equation ax2+bx+c) calculated for the sphere closer to the ray origin to determine the ray-capsule point of intersection. For example, for the ray-capsule intersection test of ray 816, sphere 804 is determined to intersect ray 816 closer to its origin O. Accordingly, to determine the ray-capsule point of intersection, the quadratic equation is solved using the quadratic coefficients calculated for sphere 804 (e.g., using quadratic coefficients calculated from values corresponding to the origin and direction of ray 816 and the center and radius of the sphere 804).

The method 700 described above determines the closest shape (e.g., closest of spheres 802 and 804 and cone 806) which intersects a ray using a single ray-capsule intersection. That is, in contrast to performing three intersection tests (which includes solving three separate quadratic equations for each test and is expensive to implement in hardware) for the spheres 802 and 804 and cone 806 and then using the three ray-capsule intersection having the smallest distance to the ray origin (i.e., the intersection having minimum valid intersection distance from the ray origin) as the final point of intersection, the example method 700 described above uses a single ray-capsule intersection and, therefore, solves a single quadratic equation (i.e., the quadratic equation resulting in the smallest t-value) to perform the ray-capsule intersection test. The ray-capsule intersection testing according to the first example, (i.e., the operations shown in FIG. 7) can be implemented via hardware, software, or a combination of hardware and software.

Also, in the example method 700 described above, the computationally expensive transcendental (i.e., non-algebraic) operations used to solve the single quadratic equation is performed at the end of the ray tracing pipeline, which improves hardware throughput. Additionally, if the ray is determined to not intersect the capsule, the computationally expensive transcendental (i.e., non-algebraic) operations are avoided because no quadratic equation is solved. Accordingly, the ray-capsule intersection test in method 700 is performed more efficiently (e.g., in less time and less power consumption) than conventional ray-capsule intersection techniques.

While the ray-capsule intersection method 700 is more efficient than conventional ray-capsule intersection techniques (as described above), when the distance between the ray origin and the capsule (relative to the radii of the spheres) is large, the precision of the ray-capsule intersection method 700 can be negatively affected (e.g., floating point error due to an insufficient number of decimal places which increases the probability of false intersections or misses occurring).

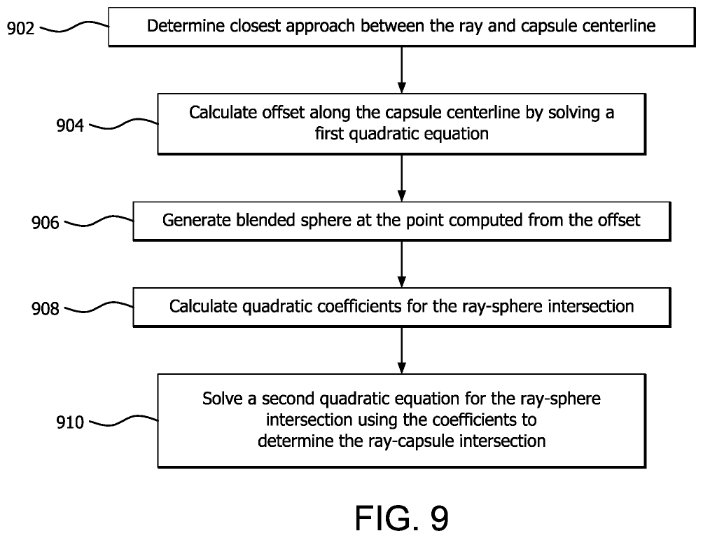

FIG. 9. is a flow diagram illustrating a method 900 of performing a ray-capsule intersection test (shown at block 508 in FIG. 5) according to a second example. As described in more detail below, the example method 900 includes solving two quadratic equations (which is still more efficient than solving three quadratic equations as performed by conventional ray-capsule intersection techniques). While ray-capsule intersection tests according to the example method 900 may be performed less efficiently (in terms of time and power) than the ray-capsule intersection tests according to the example method 700, the ray-capsule intersection tests according to the example method 900 are more precise for cases when the ray origin is far from the capsule.

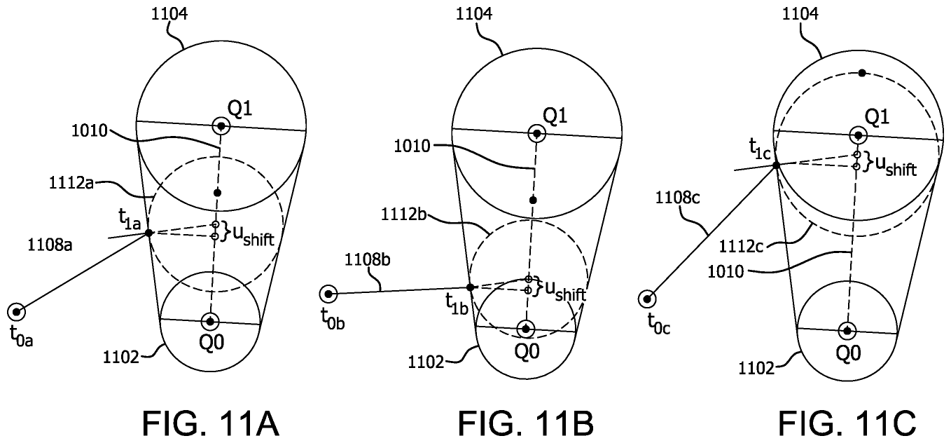

The method 900 is described with reference to FIG. 10 and FIGS. 11A-11C, which are illustrated as 2D diagrams representing a 3D space. FIG. 10 is diagram of a portion of a capsule 1002 used to illustrate a method of determining a location of a blended sphere along a centerline 1010 of the capsule 1002 according to an example. FIGS. 11A-11C are diagrams illustrating examples of a blended sphere 1112a, 1112b and 1112c (collectively blended spheres 1112) at a first, second and third location, respectively, along the centerline 1010 of the capsule 1002 based on a ray 1108a, 1108a and 1108a (collectively blended spheres 1108) intersecting a corresponding sphere. The diagrams shown in FIG. 10 and FIGS. 11A-11C are two dimensional (2D) of a 3D space.

Because a capsule is created by a swept sphere (e.g., the region of the cone through which the sphere can move), a blended sphere can be interpolated from the parameters of the two end spheres of the capsule and used to determine a ray-capsule intersection. That is, as described in more detail below, an intersection between the ray and the blended sphere corresponds to the same point (e.g., location in a 3D space) of intersection between the ray and the capsule, and can therefore be used to determine the ray-capsule intersection.

The location of a blended sphere is determined by the resulting solution of a first quadratic equation, which is solved by: 1) determining a closest approach (i.e., a smallest distance) between a point along a ray intersecting the blended sphere and a point along the centerline of the capsule as described below with reference to block 902; and 2) calculating an offset along the centerline of the capsule, as described below with reference to block 904.

As shown at block 902 in FIG. 9, the method 900 includes determining a smallest distance (i.e., a closest approach) between a ray and a centerline of a capsule. For example, FIG. 10 is diagram of a portion of a capsule 1002, including sphere 1004 and cone 1006, used to illustrate a method of determining a location of a blended sphere (e.g., blended spheres 1112 shown in FIG. 11A-11C) along a centerline 1010 (e.g., shown intersecting the center Q) of the capsule 1002 according to an example. The diagram shown in FIG. 10 represents a linear system with two variable values (tc and uc). The linear system is used to calculate the smallest distance w between the point tc along the ray 1008 intersecting the blended sphere 1004 and the point uc along the centerline 1010 of the capsule 1002.

The value t represents a point (e.g., location) along the ray 1008 (e.g., location on the ray from the ray origin t0) and the value u represents a point (e.g., location) along the centerline 1010 having a normalized value between 0 and 1, where 0 is a value representing a point (e.g., location) along the centerline 1010 at one end of the capsule 1002 and 1 is a value representing a point (e.g., location) along the centerline 1010 at the opposing end of the capsule 1002.

As shown in FIG. 10, the ray 1008 extends from its origin to and intersects the sphere 1004 between points t1 (i.e., first point of intersection) and tc (i.e., last point of intersection) before exiting the sphere 1004. In the example shown in FIG. 10, the smallest distance (i.e., closest approach) w is determined as the distance between the last point of intersection tc along the ray 1008 and point uc along the centerline 1010 of the capsule 1002. In other examples, the smallest distance can be between any point of intersection between the ray-sphere intersection and a point along the centerline of the capsule.

As shown at block 904 in FIG. 9, the method 900 includes calculating an offset along the capsule centerline by solving a first quadratic equation. That is, the location of the blended sphere 1004 (centered at u=uc+ushift) is determined by shifting the value uc by an offset value ushift. The offset value ushift is determined by solving the first quadratic equation. For example, with reference to FIG. 10, the offset ushift along the capsule centerline 1004 is calculated by solving a first quadratic equation for ushift such that the point of intersection between the ray 1008 and the blended sphere 1004 corresponds to the same point as the ray-capsule intersection. For example, with reference to FIG. 10, the offset ushift is a distance that the blended sphere 1004 is shifted along the centerline from point uc by solving for ru using the geometric (e.g., the angle ⊖, w and ru) parameters shown in FIG. 10 and the first quadratic equation for ushift, whose coefficients are calculated from inputs w, uc, r0, r1, Q0 Q1, and the origin and direction of the ray 1008.

That is, the blended sphere 1004 is a linear blend of the first sphere 1102 and the second sphere 1104, whose location along the centerline 1010 of the capsule 1002 is a blend factor u, as shown in below in Equation 8.

$$u = {u}_{c} + {u}_{shift} \qquad Equation 8$$

As shown at block 906 in FIG. 9, the method 900 includes generating the blended sphere at the location, along a centerline (center axis) of the capsule, calculated from the offset determined at block 904. That is, the blended sphere 1004, determined from the blend factor u, is generated at a location along the centerline 1010 of the capsule 1002 calculated from the offset u_{offset} to determine a ray-sphere intersection.

FIGS. 11A-11C are diagrams illustrating examples of blended spheres 1112 calculated from the offset u_{shift}, described at block 906. That is, blended sphere 1112a is generated at a first location along the centerline 1010 of the capsule 1002 based on ray 1108a (originating at point t₀ₐ) intersecting blended sphere 1108a at point t₁ₐ. Blended sphere 1112b is generated at a second location along the centerline 1010 of the capsule 1002 based on ray 1108b (originating at point t_{0b}) intersecting blended sphere 1108a at point t_{1b}. Blended sphere 1112b is generated at a third location along the centerline 1010 of the capsule 1002 based on ray 1108c (originating at point toc) intersecting blended sphere 1108c at point t_{1c}. The offsets u_{shift}, for each of the of blended spheres 1112, are shown in FIGS. 11A-11C and are calculated as described above.

As shown at block 908 in FIG. 9, the method 900 includes calculating quadratic coefficients for the intersection between the ray and the blended sphere (i.e., ray-sphere intersection) generated at block 906. That is, quadratic coefficients (e.g., a, b and c coefficients of the quadratic equation ax²+bx+c) for the intersection between the ray 1108 and the blended sphere are calculated from the input values of the blended sphere (e.g., a center of one of the blended spheres 1112, the radius (calculated as h₀+h_{d}(u_{c}+u_{offset}) of one of the blended spheres 1112 and the ray origin).

As shown at block 910 in FIG. 9, the method 900 includes solving a second quadratic equation for the intersection, using the quadratic coefficients calculated at block 908, to determine a final point of intersection (i.e., the ray-capsule intersection).

The ray-capsule intersection testing according to the second example, (i.e., the operations shown in FIG. 9) can be implemented via hardware, software or a combination of hardware and software.

Referring back to the method 500, after performing the ray-capsule intersection tests (e.g., using the example method 700 in FIG. 7 or the example method 900 in FIG. 9), the curves of the scene are rendered, at block 510, (along with rendering other primitives, such as triangles, used to represent objects of the scene) using the accelerated hierarchy structure, such as a BVH (e.g., BVH tree 606 shown at FIG. 6B) to implement the ray tracing. For example, objects (including curved objects or curved portions of objects, as well as other objects) are rendered on a display, such as display device 118.

In another example, curves are rendered by switching between a first ray-capsule intersection test mode and a second ray-capsule intersection test mode.

FIG. 12 is a flow diagram illustrating an example method 1200 of rendering curves using ray tracing according to features of the present disclosure. The operations at blocks 1202, 1204 and 1206 in FIG. 12 are performed in the same manner as described above with regard to the operations at blocks 502, 504 and 506 of FIG. 5.

At block 1202, curves are tessellated into a chain of capsules. The objects in a scene are tessellated into primitives (e.g., capsules, triangles, or other primitives), which includes tessellating each curve into a chain of capsules. For example, as shown in FIG. 6A, the primitives include a capsule chain 604 comprising capsule 602a and 602b, capsule 602c and triangle 602d. The capsule chain 604 is used to represent a curve of a portion of an object in the scene. The portion of an object can be a part of the object or the whole object. Each capsule is the convex hull of two spheres and neighboring capsules on a chain share endpoints. For example, as shown in FIG. 6A, capsules 602a and 602b of capsule chain 604 share endpoints (e.g., points on the middle sphere of the capsule chain 604).

Data for the two spheres of a capsule, including data representing the location and radii of the spheres, is stored for example using 32-bit floating point values (e.g., two float4 values). An inverse-length term can also be included to avoid a division (i.e., avoiding the division of data for both spheres) in the ray tracing pipeline. An amount of memory (e.g., 32 bytes or more) is allocated for data representing each capsule to facilitate an efficient ray tracing pipeline. For example, the reciprocal of the length of the capsule is precomputed in software and used throughout the ray tracing pipeline to avoid expensive computation using hardware. Additional bytes (e.g., 64 bytes or more) of data can be precomputed, leading to a small tradeoff between an amount of storage used for precomputation and pipeline depth

As shown at block 1204, an acceleration structure, which comprises the capsules, is generated. That is, an acceleration structure (e.g., BVH structure) is generated which includes the capsules and other primitives of the scene. For example, the accelerated BVH structure (i.e., the BVH tree representation 606) in FIG. 6B is generated which includes the capsules 602a, 602b and 602c and triangle 602d. As described above with regard to the BVH tree representation 404 in FIG. 4, the hierarchy in FIG. 6B is shown in 2 dimensions for simplicity. However, extension to 3 dimensions is simple, and it should be understood that the tests described herein would generally be performed in three dimensions. In addition, the non-leaf nodes of the BVH tree representation 604 are represented with the letter “N” and the leaf nodes are represented with the letter “O.”

As shown in the BVH tree representation 606 at FIG. 6B, capsule 602a is represented by leaf node O₁, capsule 602b is represented by leaf node O2, capsule 602c is represented by leaf node O3, and triangle 602d is represented by leaf node O4. A ray tracing pipeline operates similarly to the operation discussed above with regard to FIG. 4. For example, the BVH tree 606 is traversed similar to the traversal of the BVH tree 404.

As shown at block 1206, rays are cast in a space (e.g., 3D space). For example, a ray is cast in a space which includes the example primitives 602a to 602d shown in FIG. 6A.

As described above, both examples of ray-capsule intersection testing are more efficient than conventional ray-capsule intersection techniques. In addition, the ray-capsule intersection testing according to the second example may be performed less efficiently (in terms of time and power because of solving two quadratic equations instead of a single quadratic equation) than the ray-capsule intersection testing according to first example, the ray-capsule intersection implemented according to the second example is more precise for cases when the ray origin is far from the capsule.

Accordingly, curves in a scene can be rendered by switching between a first ray-capsule intersection testing mode (i.e., performing ray-capsule intersection testing according to the first example) to save time and power for cases when the ray origin is not far from the capsule and a second ray-capsule intersection testing mode (i.e., performing ray-capsule intersection testing according to the second example) to increase precision for cases when the ray origin is far from the capsule.

Use of the first mode or the second mode can be based on a distance between the capsule and an origin of a corresponding ray. For example, as shown at decision block 1208, the example method 1200 includes determining whether a distance between the capsule and a ray origin is equal to or greater than a threshold distance.

In response to determining that the distance between the capsule and the ray origin is not equal to or greater than a threshold distance (i.e., less than a threshold distance), the ray intersection testing is performed using the first mode, at block 1210, to save additional time and power consumption.

In response to determining that the distance between the capsule and the ray origin is equal to or greater than a threshold distance, the ray intersection testing is performed using the second mode at block 1212, to increase the precision of the ray-capsule intersection testing.

The determination of whether to use the ray intersection testing can be implemented via hardware, software or a combination of hardware and software.

As shown at block 1214, the curves of the scene are rendered (along with rendering other primitives, such as triangles, used to represent objects of the scene) using the accelerated hierarchy structure.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for rendering curves using ray tracing, the method comprising:
tessellating a curve, representing at least a portion of an object in a scene, into a chain of capsules each comprising a first sphere, a second sphere and a cone connecting the first sphere and the second sphere;
generating an acceleration structure comprising the chain of capsules;
casting a ray in a space comprising the curve;
performing, for a capsule of the chain of capsules, a closed-form intersection test between the ray and the capsule using a single quadratic equation; and
rendering the curve based on the closed-form intersection test.

2. The method of claim 1, further comprising performing the closed-form intersection test between the ray the capsule without calculating an additional quadratic equation.

3. The method of claim 1, further comprising:
calculating quadratic coefficients for the closed-form intersection test from input values of the first sphere and the second sphere; and
determining whether the ray intersects the cone based on the quadratic coefficients.

4. The method of claim 3, further comprising determining whether the ray intersects the cone in one of:
a first region between the first sphere and the second sphere; and
a second region outside of the first region.

5. The method of claim 4, further comprising:
in response to a determination that the ray intersects the cone in the first region between the first sphere and the second sphere, solving the single quadratic equation using the quadratic coefficients for the closed-form intersection test.

6. The method of claim 5, further comprising:
in response to a determination that the ray intersects the cone in the second region outside of the first region, calculating quadratic coefficients for a ray-sphere intersection of the first sphere and a ray-sphere intersection of the second sphere;
determining which of the first sphere and the second sphere is closer to a ray origin, along the ray, using the quadratic coefficients for the ray-sphere intersection of the first sphere and the ray-sphere intersection of the second sphere; and
determining a final point of intersection between the ray and the capsule using the quadratic coefficients for the ray-sphere intersection.

7. A processing device for rendering curves using ray tracing, the processing device comprising:
memory; and
a processor configured to:
tessellate a curve, representing at least a portion of an object in a scene, into a chain of capsules each comprising a first sphere, a second sphere and a cone connecting the first sphere and the second sphere;
generate an acceleration structure comprising the chain of capsules;
cast a ray in a space comprising the curve;
perform, for a capsule of the chain of capsules, a closed-form intersection test between the ray and the capsule using a single quadratic equation; and
render the curve based on the closed-form intersection test.

8. The processing device of claim 7, wherein the processor is configured to performing the closed-form intersection test between the ray the capsule without calculating an additional quadratic equation.

9. The processing device of claim 7, wherein the processor is configured to:
calculate quadratic coefficients for the closed-form intersection test from input values of the first sphere and the second sphere stored in the memory; and
determine whether the ray intersects the cone based on the quadratic coefficients.

10. The processing device of claim 9, wherein the processor is configured to determine whether the ray intersects the cone in one of:
a first region between the first sphere and the second sphere; and
a second region outside of the first region.

11. The processing device of claim 10, wherein the processor is configured to:
in response to a determination that the ray intersects the cone in the first region between the first sphere and the second sphere, solving the single quadratic equation using the quadratic coefficients for the closed-form intersection test.

12. The processing device of claim 11, wherein the processor is configured to:
in response to a determination that the ray intersects the cone in the second region outside of the first region, calculating quadratic coefficients for a ray-sphere intersection of the first sphere and a ray-sphere intersection of the second sphere;
determining which of the first sphere and the second sphere is closer to a ray origin, along the ray, using the quadratic coefficients for the ray-sphere intersection of the first sphere and the ray-sphere intersection of the second sphere; and
determining a final point of intersection between the ray and the capsule using the quadratic coefficients for the ray-sphere intersection.

13. A method for rendering curves using ray tracing, the method comprising:
tessellating a curve, representing at least a portion of an object in a scene, into a chain of capsules each comprising a first sphere, a second sphere and a cone connecting the first sphere and the second sphere;
generating an acceleration structure comprising the chain of capsules;
casting a ray in a space comprising the curve;
for a capsule of the chain of capsules:
determining a smallest distance between the ray and a centerline of the capsule;
calculating an offset along the centerline of the capsule; and
performing a ray-capsule intersection test based on an intersection between the ray and a blended sphere generated from the offset; and
rendering the curve based on the ray-capsule intersection test.

14. The method of claim 13, wherein calculating the offset along the centerline of the capsule comprises solving a first quadratic equation.

15. The method of claim 13, wherein the offset is a distance that the blended sphere is shifted along the centerline of the capsule.

16. The method of claim 13, further comprising:
generating the blended sphere at a location along the capsule based on the offset;
calculating quadratic coefficients from input values of the blended sphere; and
performing the ray-capsule intersection test using a second quadratic equation based on the quadratic coefficients of the blended sphere.

17. A processing device for rendering curves using ray tracing, the processing device comprising:
memory; and
a processor configured to:
tessellate a curve, representing at least a portion of an object in a scene, into a chain of capsules each comprising a first sphere, a second sphere and a cone connecting the first sphere and the second sphere;
generate an acceleration structure comprising the chain of capsules;
cast a ray in a space comprising the curve;
for a capsule of the chain of capsules:
determine a smallest distance between the ray and a centerline of the capsule;
calculate an offset along the centerline of the capsule; and
perform a ray-capsule intersection test based on an intersection between the ray and a blended sphere generated from the offset; and
render the curve based on the ray-capsule intersection test.

18. The processing device of claim 17, wherein the processor is configured to calculate the offset along the centerline of the capsule by solving a first quadratic equation and the offset is a distance that the blended sphere is shifted along the centerline of the capsule.

19. The processing device of claim 17, further comprising a display device, wherein the at least the portion of the object is rendered on the display device.

20. The processing device of claim 17, wherein the processor is configured to calculate quadratic coefficients from input values of the blended sphere stored in the memory.
